(19) United States
(12) Patent Application Publication
(10) Pub. No.: US 2024/0145838 A1
(43) Pub. Date: May 2, 2024

(54) LIGHTWEIGHT, COMPACT, HIGH POWER DENSITY BATTERY PACK WITH SOLAR CHARGING CAPABILITY

(71) Applicant: APTERA MOTORS CORP., San Diego, CA (US)

(72) Inventors: Luke BOCKMAN, Del Mar, CA (US); Daniel THORP, Poway, CA (US); Diego MEDINA, San Diego, CA (US); Thomas HART, Broomfield, CA (US); Ahmed FOUAD, Encinitas, CA (US)

(73) Assignee: APTERA MOTORS CORP., San Diego, CA (US)

(21) Appl. No.: 18/501,001

(22) Filed: Nov. 2, 2023

Related U.S. Application Data
(60) Provisional application No. 63/381,935, filed on Nov. 2, 2022.

(51) Int. Cl. H01M 50/249; H01M 10/42; H01M 10/46; H01M 10/48; H01M 10/613; H01M 10/625; H01M 10/643; H01M 10/653; H01M 10/6556; H01M 10/658; H01M 50/213; H01M 50/507

(52) U.S. Cl. CPC H01M 50/249; H01M 10/425; H01M 10/465; H01M 10/482; H01M 10/486; H01M 10/613; H01M 10/625; H01M 10/643; H01M 10/653; H01M 10/6556; H01M 10/658; H01M 50/213; H01M 50/507; H01M 2010/4271; H01M 2220/20

(57) ABSTRACT

A high power density battery pack for a solar-electric vehicle includes a frame with compartments for battery modules arranged therein. The modules are in thermal communication with a unitary cooling plate disposed underneath. The modules include an array of secondary cells arranged in bottom and top carriers. The bottoms of the cells are in thermal communication with a heat spreader. The cells are oriented with their electrodes in a common plane and electrically isolated by the top carrier. One or more potting materials fills the interstitial spaces between the cells. The cells are connected in parallel and series by interconnects. A module monitoring system tracks the voltage and temperature of the modules. Modules are connected in series by intra-row and inter-row interconnects. A battery management system provides a solar charging mode for both stationary and in-motion vehicle operation, and a low-power quiescent mode when the vehicle is powered down.

### CROSS-REFERENCE TO RELATED APPLICATION

This application is a conversion of, and claims the benefit of, co-pending U.S. Provisional Patent Application No. 63/381,935, entitled “High Power Density Battery Pack With Solar Charging Capability”, filed on Nov. 2, 2022, which is incorporated herein by reference in its entirety.

### TECHNICAL FIELD

The present disclosure relates to a battery pack and, more particularly, to an apparatus, system and method of manufacture of a high-power density battery pack suitable for vehicular propulsion and solar mobility whereby the battery pack is capable of recharging from vehicle-integrated solar panels to provide a suitable vehicular range.

### BACKGROUND

Solar-electric vehicles use solar panels having photovoltaic (PV) cells and a battery to convert sunlight into electrical power for propulsion by means of one or more electric motors. The battery functions as the main power source for electric vehicles and can be constructed from, for example, one or more battery cells arranged into individual modules with these modules grouped together to form a pack. Conventional solar-electric vehicles with battery packs have yet to provide a suitable range for daily use (e.g., ≥30 miles) because of numerous factors including vehicle weight, aerodynamics and the design of the battery pack itself. As a result, there is a need for a solar-charged vehicle having a suitable range, such as 30-40 miles per day of pure solar charging, to provide day-to-day transportation.

Electric vehicles in general require a large quantity of power for day-to-day transportation. For example, if a vehicle uses 500 W-hr/mile then for a 100 mile range the vehicle would need 50 kWh of power. This same battery pack, if used to power a vehicle with an efficiency of, say, 100 W-hr/mile, could provide 500 miles of range. To achieve these power requirements, the battery pack of electric vehicles typically includes a large, dense arrangement of individual cells, individually placed or configured into a plurality of modules. The performance of the battery pack will depend on the characteristics of the individual battery cells, the total number of individual cells that are incorporated into the battery pack, and other materials and design considerations. The battery pack often represents one of the most expensive and massive assemblies in the electric vehicle.

Recently there is significant electric vehicle demand for a battery pack that can store >50 kWh of energy to provide a suitable vehicular range. Conventional automotive vehicle battery packs have added weight due to framing, complex cooling channels, and other structures. These battery packs also have a large physical volume and low battery pack energy density. In view of such disadvantages, these battery packs cannot meet the demands of an ultra-efficient vehicle design such as, for example, smaller physical dimensions, higher power density, and less weight.

Accordingly, there is a long felt need for an ultra-compact, lightweight, energy dense battery pack capable of being recharged by the sun with sufficient capacity to enable a practical solar charged vehicle, which overcomes the aforementioned disadvantages.

### SUMMARY

The present invention solves these problems by minimizing the amount and weight of the materials used, minimizing the volume of the pack beyond the volume of the cell arrays, and maximizing the density of the cell arrays. It further includes a cooling system with superior uniformity and efficiency, thereby contributing to the overall efficiency of the vehicle. It further includes a novel solar charging mode and low power draw mode.

It is an object of the present disclosure to provide a battery pack that is compatible with automotive, aeronautical and space application requirements.

It is an object of the present disclosure to provide a battery pack that may be mass produced at low cost.

Other desirable features and characteristics will become apparent from the subsequent detailed description, the drawings, and the appended claims, when considered in view of this background.

### DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations, wherein:

FIG. 1A illustrates a perspective view of the overall battery pack architecture, according to an embodiment of the present invention;

FIG. 1B illustrates an exploded perspective view of the overall battery pack architecture, according to an embodiment of the present invention;

FIG. 2 illustrates an exploded perspective view of the battery pack module array and interconnect system, according to an embodiment of the present invention;

FIG. 3 illustrates a perspective view of the battery pack cooling plate, according to an embodiment of the present invention;

FIG. 4 illustrates an exploded perspective view of the battery pack module, according to an embodiment of the present invention;

FIG. 5A illustrates a detail perspective view of a stamped cell-to-cell connector scheme of a battery module, according to an embodiment of the present invention;

FIG. 5B illustrates a detail perspective view of a solid intra-row module-to-module connector scheme of a battery module array, according to an embodiment of the present invention;

FIG. 5C illustrates a detail perspective view of a ribbon bonded cell-to-cell connector scheme of a battery module, according to an embodiment of the present invention;

FIG. 5D illustrates a detail perspective view of a stress-relieved intra-row module-to-module connector scheme of a battery module array, according to an embodiment of the present invention;

FIG. 6 illustrates a detail section view of a battery module, according to an embodiment of the present invention;

FIG. 7 illustrates an exploded front, right, bottom perspective view of a battery management system compartment and power distribution unit for a battery pack, according to an embodiment of the present invention; and

FIG. 8 illustrates a top schematic view of unitary cooling plate having one or more perforated baffles that influences uniform fluid flow and/or temperature adsorption, according to an embodiment of the present invention.

### DETAILED DESCRIPTION

Non-limiting embodiments of the present invention will be described below with reference to the accompanying drawings, wherein like reference numerals represent like elements throughout. While the invention has been described in detail with respect to the preferred embodiments thereof, it will be appreciated that upon reading and understanding of the foregoing, certain variations to the preferred embodiments will become apparent, which variations are nonetheless within the spirit and scope of the invention. For a better understanding of the present invention, reference will be made to the following Detailed Description, which is to be read in association with the accompanying drawings, which are incorporated in and constitute a part of this specification, show certain aspects of the subject matter disclosed herein and, together with the description, help explain some of the principles associated with the disclosed implementations.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “some embodiments”, “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are provided for the purposes of illustrating some embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

### EMBODIMENTS

One or more aspects of the present disclosure relate to energy storage systems including a modular battery pack that need only be supported along an outer perimeter. The modular battery pack may further include one or more characteristics or features that can be combined within the structural frame holding the battery pack modules. Aspects of the various features are described here and below. In one aspect, such features can include the structural frame of the battery pack corresponding to a sealed container which contains energy storage modules. The energy storage modules contain cell units and arrays thereof and may include potting material such as resin. The resin can be selected and implemented according to thermal and structural performance requirements. In another aspect, such features can include arrays of small or large format cells having all positive and negative electrical terminals aligned in-plane on a common face of the product assembly. In still another aspect, such features can include components for thermal management of the cell arrays including various components for passively or actively cooling the cell arrays. In yet another aspect, such features can include materials to electrically insulate cells from neighboring components. In a further aspect, such features include one or more thin, conductive bars, herein “busbars”, for electrical interconnection of cell and module terminals, and voltage sensing channels. In yet another aspect, such features can include electronics for measurement & control of module voltage/temperature.

As incorporated into various embodiments, such as electric vehicles, designers or manufacturers of energy storage systems may look to reduce the cell and overhead, non-cell, costs of the energy storage system, such as material costs, capital expenses, manufacturing expenses, and manufacturing scrap.

Additionally, designers or manufacturers may look to reduce the total volume and mass of the energy storage system, such as by maximizing the volumetric packing density of the cells, thereby maximizing the volumetric or gravimetric energy density of the storage system. Finally, consideration must be given to the assembly and manufacturing processes required to produce a given storage system design. Dramatically simplified manufacturing assembly accelerates design, launch, and scaling of high-volume automated manufacturing facilities, while for a given production capacity, reducing the required equipment footprint.

One or more aspects of the present application may address such implementation challenges and inefficiencies, individually or in combination. For example, as discussed herein, laser-welded interconnects along a common plane of the cell arrays may be used to create electrically conductive connections which are used to supply voltage and current with low resistive losses and connect voltage-sensing and controlling electronics. The common welding plane allows simple translation of the cell arrays/module to be used to create the connections, thereby reducing manufacturing footprint/operation expenditure compared to previous methods. In another example, incorporation of cell locating trays allows for dense packing of the cells while avoiding contact between the electrically conductive cell skins. In a further example, structural resin in the battery pack frame can be used to position & constrain cells in the final product, counteract inertial loads from shock and vibration, effectively manage unprovoked thermal runaway, and provide additional passive heat-sinking capacity and parallel thermal pathway to an active cooling system. One skilled in the relevant art will appreciate that additional advantages or technical efficiencies may be associated with one or more aspects of the present application or combinations of aspects without limitation.

Although the various aspects will be described in accordance with illustrative embodiments and combination of features, one skilled in the relevant art will appreciate that the examples and combination of features are illustrative in nature and should not be construed as limiting.

In an illustrative embodiment the battery pack is housed in a frame structure that forms a sealed container either as a pre-fabricated sub-assembly, or after mating with features or components of the full product assembly, such as an electric vehicle. Multiple materials may be used in the construction of the frame with the materials configured as pre-assembled or serially constructed. Seals, where necessary, may be formed by the weight of the components to be joined, by fasteners, or by additional activation techniques, such as thermal or ultra-violet light curing and/or additional pressure applied during the manufacturing process. The frame structure may include various mechanical or electrical interfaces for constraining or interconnecting other functional components. For example, the frame structure may include fixtures or attach points for the electronic control systems, cables, connectors and/or cooling system plumbing. The frame structure can also include additional components or features for facilitating cell-level, module-level, and pack-level performance in thermal runaway events.

The frame may be configured or constructed with one or more cavities or defined areas for receiving a set of cell arrays or modules including cell arrays. The frame can be constructed with structural properties adequate for suspending the mass of the cell arrays or cell modules within the defined area. Additionally, the frame can further be constructed to tolerate or manage unintended loads or impacts from above, below or the side of the frame structure to protect the functional integrity of the cell arrays or modules or the battery pack as a whole. Coatings, insulating washers, dielectric sheets or other insulating elements may be inserted between the frame and the wires, busbars, interconnects and other portions of the vehicle in order to isolate it from the electrical system.

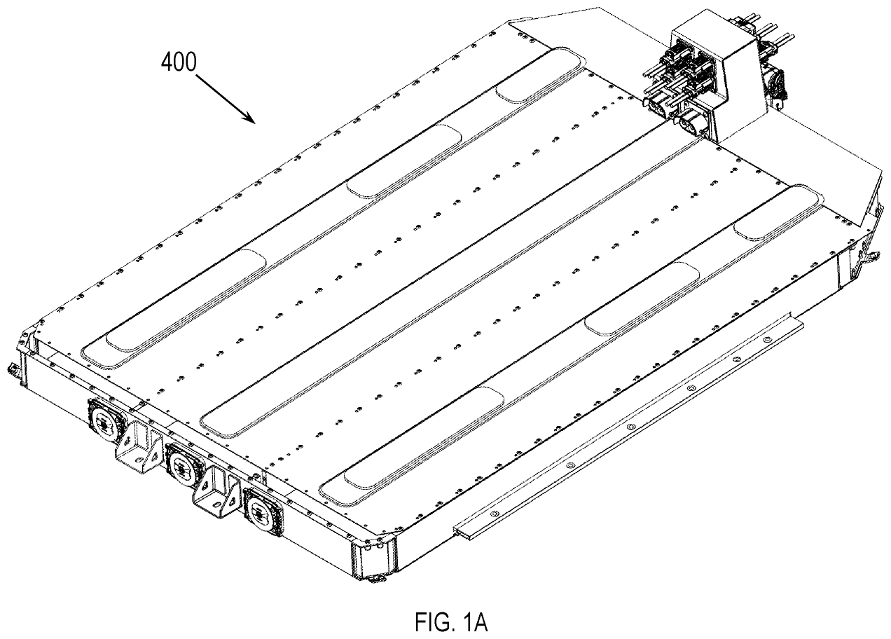

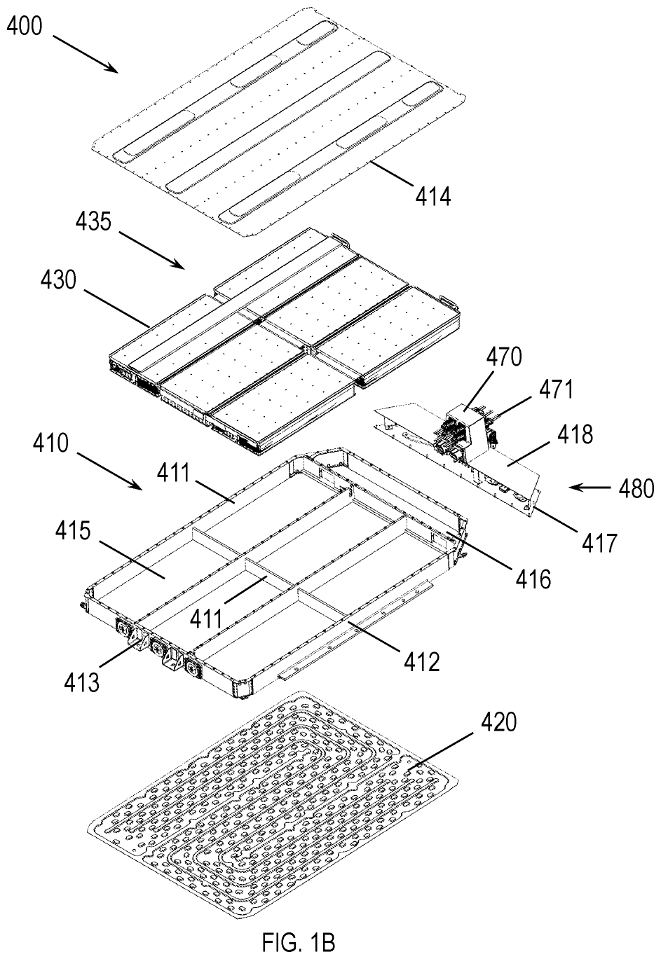

Referring to FIGS. 1A-1B, the battery pack 400 may be housed in a frame 410 constituting a sealed container including various components and features described herein. In FIG. 1B an exploded view of the battery pack is presented which shows the various major components and a clearer view of the frame 410 structure. The frame 410 may be primarily composed of extruded metal beams, such as aluminum beams, welded or fastened together. The frame 410 may comprise frame walls and dividers 411 which form an array of module compartments 415. Frame walls 411 may also be used to define a compartment 416 which houses the battery management system (BMS) 480. The BMS compartment 416 is sealed by top 418 and bottom 417 enclosures. The top enclosure 418 may comprise an opening to receive the power distribution unit (PDU) 470. The PDU 470 may be attached to the top side of the BMS compartment 418 and may be fitted with connectors 471 for the power distribution cabling. In one embodiment, the frame structure 410 may include a top lid 414 that may be mechanically stable against high velocity gas erosion in the event of battery cell thermal runaway. The frame lid 414 may be constructed of materials that exhibit high melting temperature and/or high thermal resistance to protect the cell array from harmful convective heat transfer, such as a thermoplastic, mineral, or electrically insulated metallic sheet. In some embodiments, the lid 414 can serve as a dielectric insulation barrier between cells/electronics and the battery enclosure 410. A cooling plate 420 may form the bottom of the frame and adds structural integrity thereto.

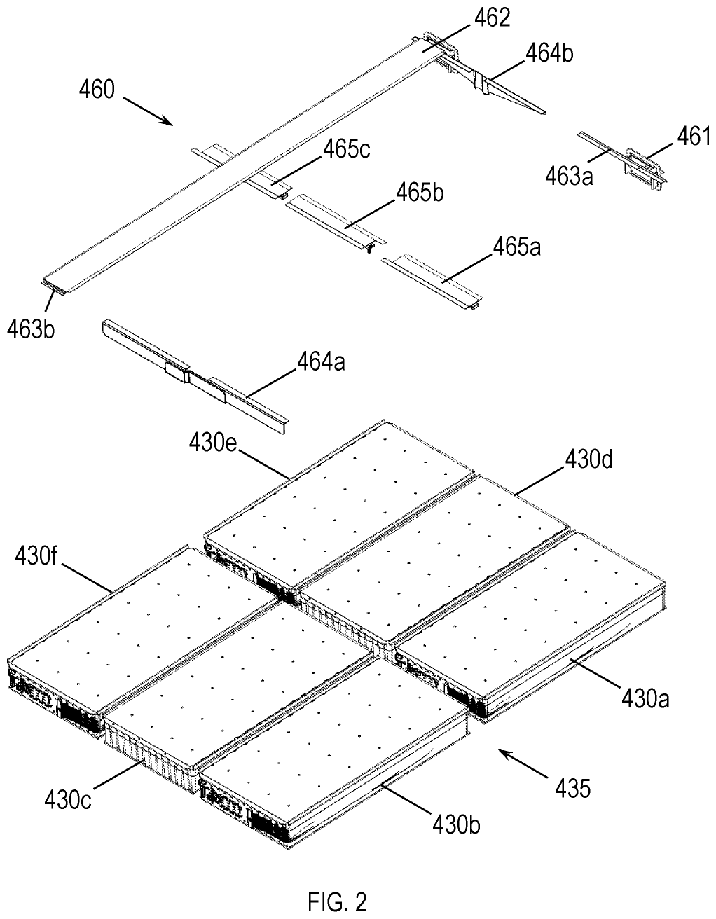

The frame encloses and supports an array of modules 435, as shown in FIG. 2. The modules 430a-430f may be electrically connected in series or parallel by an interconnect system 460. In one embodiment, the modules 435 may be connected in series in a serpentine arrangement. A positive terminal 461 comprising a first tab soldered to an end-of-row busbar 463a may be soldered to the positive end of a first module 430a. The negative end of the first module 430a may be connected to the positive end of a second module 430b via an intra-row busbar 465a. The negative end of the second module 430b may be connected to the positive end of a third module 430c in an adjacent row via an inter-row busbar 464a. In a similar way, modules within rows may be connected via intra-row busbars 465a-465c and rows may be connected via inter-row busbars 464a and 464b. The negative end of the module array 435 may be fitted with a negative terminal 462 comprising a busbar and second tab soldered to an end-of-row busbar 463b which may be soldered to the negative end of a sixth module 430f.

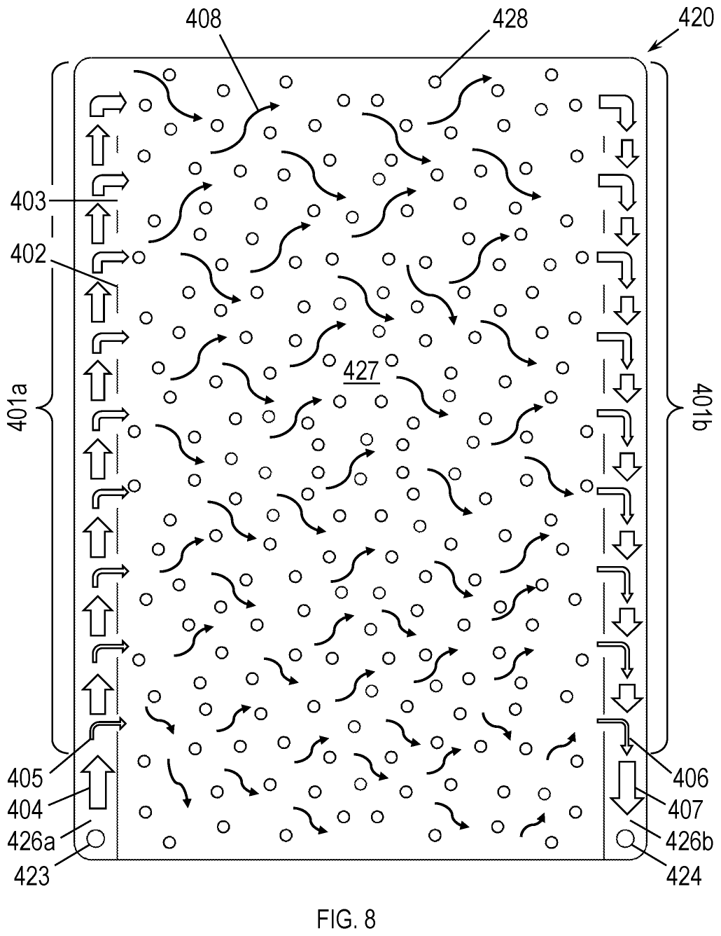

An alternative embodiment of the unitary cooling plate, illustrated schematically in FIG. 8, comprises an inlet 423, an inlet channel 426a, an inlet baffle 401a, a flow zone 427, an outlet baffle 401b, and an outlet 424. The cooling plate baffles 401a, 401b comprise a perforated baffle wall 402 having gaps 403 therein. In operation, the short inlet channel 426a may feed the inlet baffle main flow 404, which is periodically siphoned through the gaps 403 as inlet baffle distribution flows 405. Note that the baffle walls 402 may be of non-uniform length and the gaps 403 of non-uniform width. Since the inlet baffle main flow 404 increases in temperature with distance from the inlet 423, it has less cooling power as it travels along the main baffle flow 404. Consequently, the baffle wall 402 lengths and gap 403 widths may be chosen to reduce the distribution flow 405 near the inlet 423 and increase it away from the inlet 423, thereby compensating the decreased cooling power with increased flow rate to create a more uniform cooling injection pattern. The coolant then passes through the cooling plate flow zone 427 where it is induced into turbulent flow by dimples 428 or other small impediments, which may be uniformly or randomly disposed. The flow pattern is generally indicated by arcuate arrows 408, which illustrate the rate of flow by the magnitude of their length, i.e. shorter arrows mean lower flow rate and longer arrows mean higher flow rate. The higher flow rate for the higher temperature coolant and lower flow rate for the lower temperature coolant result in a substantially uniform cooling profile of the cooling plate 420. At the opposite end of the cooling plate 420, and output baffle 401b collects the flow 406 and channels it into a main output baffle flow 407, which feeds into the outlet channel 426b, and is discharged through the outlet port 424. Computational fluid dynamics may be used to optimize the cooling profile for a particular battery pack and may be informed by knowledge of the heat profile of the primary and/or secondary cells therein. In this way a substantially uniform, and therefore more efficient, cooling plate may be realized.

The inter-row busbars 464a-464b offer advantages for the low-profile, high-density battery pack. In a first advantage the busbars 464a-464b may be formed from stamped sheet metal and may have a low profile without any protrusions thereby minimizing the height of the battery pack above the secondary cells 440. In a second advantage, all busbar connections may be made from the top of the module 430; no access to the module bottom would be required. Consequently, the busbars 464 may be welded to the end-of-module busbars 463 using the same technique and equipment used to make the ribbon bonds. The busbars 464a-464c may be made from any suitable metal, such as aluminum or copper, with aluminum preferred for weight savings, a third advantage. In a fourth advantage, the busbars 465a-465c may comprise strain relief features, including welding tabs and deformable traces, which allow the modules to move relative to each other without the buildup of failure-level stresses on the busbar 465a-465c welds. In this way, thermal expansion, flexing and torsion of the frame does not transfer large stresses to the module interconnects 460.

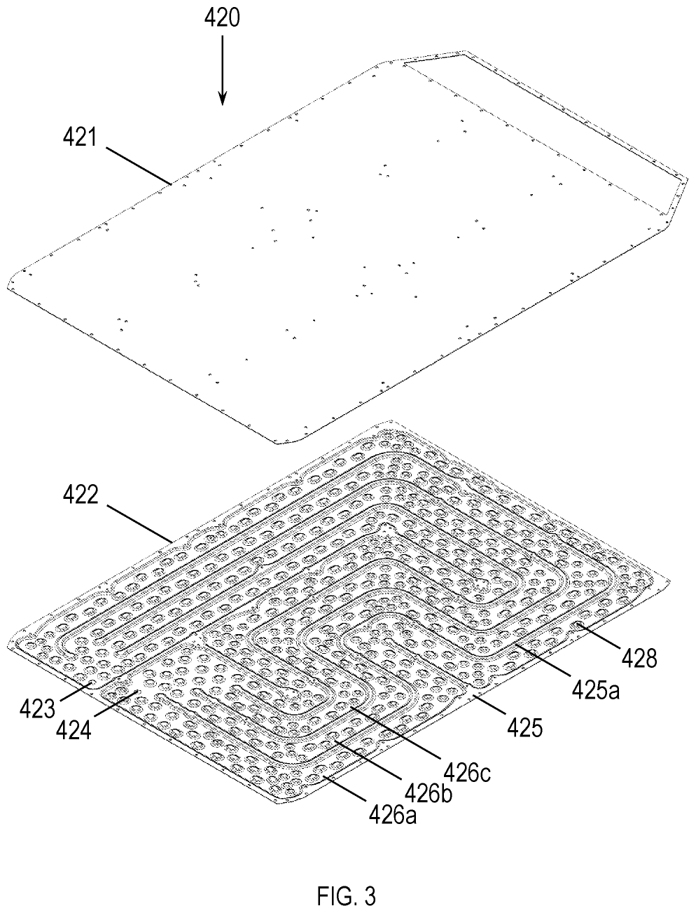

Referring to FIG. 1B, the frame 410 may include a unitary cooling plate 420 for all of the modules 430 in the battery pack 400. The cooling plate, shown in FIG. 3, may comprise an inlet 423, an outlet 424 and a plurality of flow paths or channels 426a-426c. The sections may be formed from top 421 and bottom 422 panels, with the bottom panel 422 facing the interior of the vehicle and the top panel 421 in contact with the battery pack 400. In FIG. 3, the bottom panel 422 can be seen to include holes which serve as inlet 423 and outlet 424. Stamped raised portions 425 may provide mating surfaces around the perimeter of the bottom panel 422. Top 421 and bottom 422 panels may be joined by braising, welding, fastening or bonding with thermally conductive adhesive. An elongated ridge 425a may be used to form a flow barrier which can be used to form channels 426a-426c. Within the channels 426a-426c other, raised dimples 428 may be used to cause turbulent flow which disrupts the boundary layer thereby increasing the efficiency of heat transfer from the cooling plate 420 to the coolant. The cooling plate 420 may be coupled to the modules 430 via a thermally conductive paste or adhesive disposed between the module base plate 431 and the cooling plate 420. Module base plate 431 may be characterized as thermally conductive.

The unitary cooling plate 420 with single inlet 423 and outlet 424 for multiple modules has advantages over conventional designs. First, a battery pack-level cooling plate may reduce the piece part count, e.g., number of cooling plates, for a module-based battery pack, while adding structural rigidity relative to module-level cooling. Second, single inlet 423 and outlet 424 ports may reduce plumbing components, e.g. distribution tubes and fittings, assembly time, cost and potential for leakage. Third, the reduced component count may reduce the overall weight of the battery pack and integrated cooling system. The specific, multi-channel design of the present cooling plate also offers advantages. For example, the flow can be tailored to enable uniform cooling of modules 430 and cells 440 in large arrays. Fourth, the use of small, raised dimples 428 within the channel may induce eddy currents which break up the boundary layer and increase cooling efficiency.

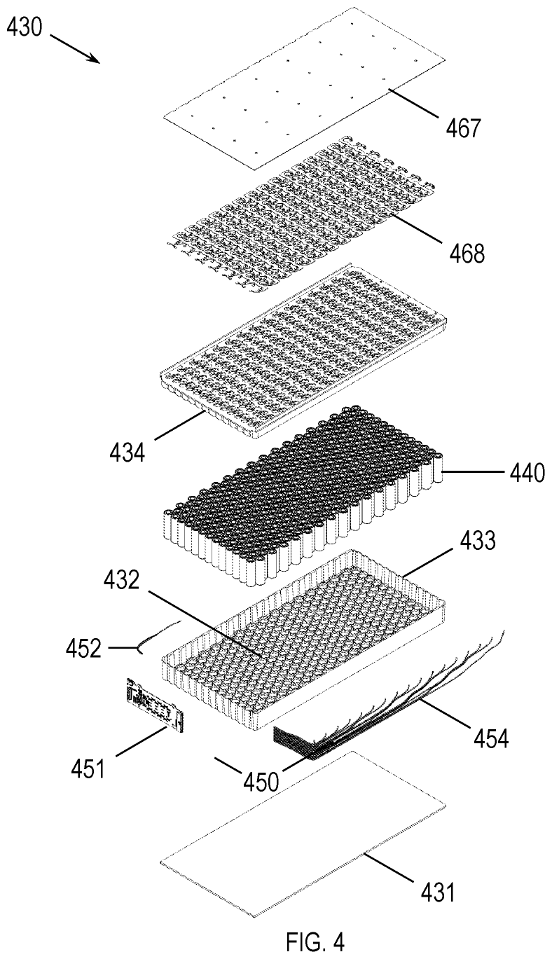

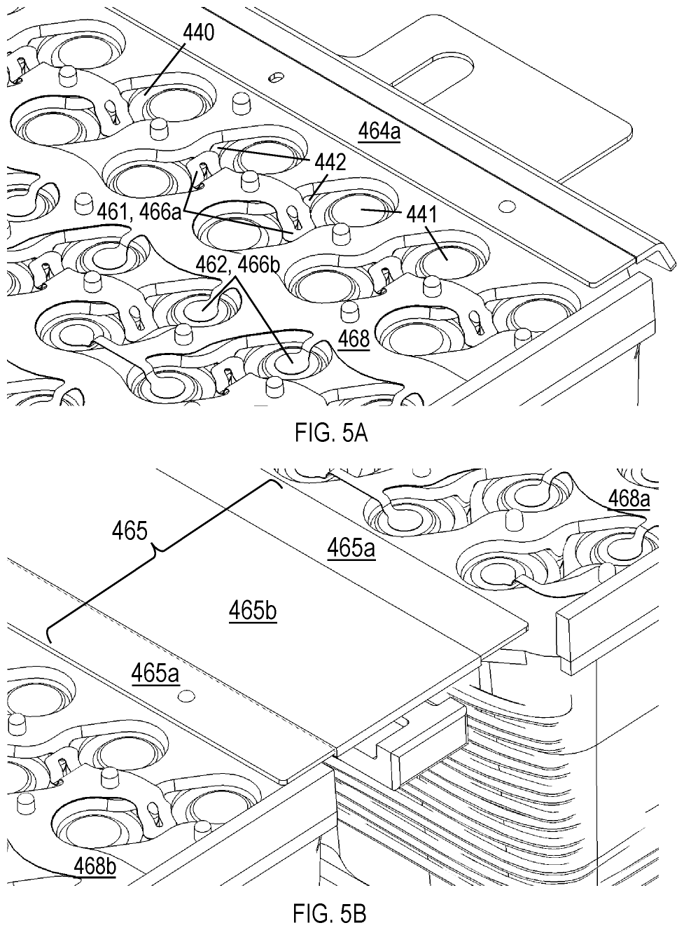

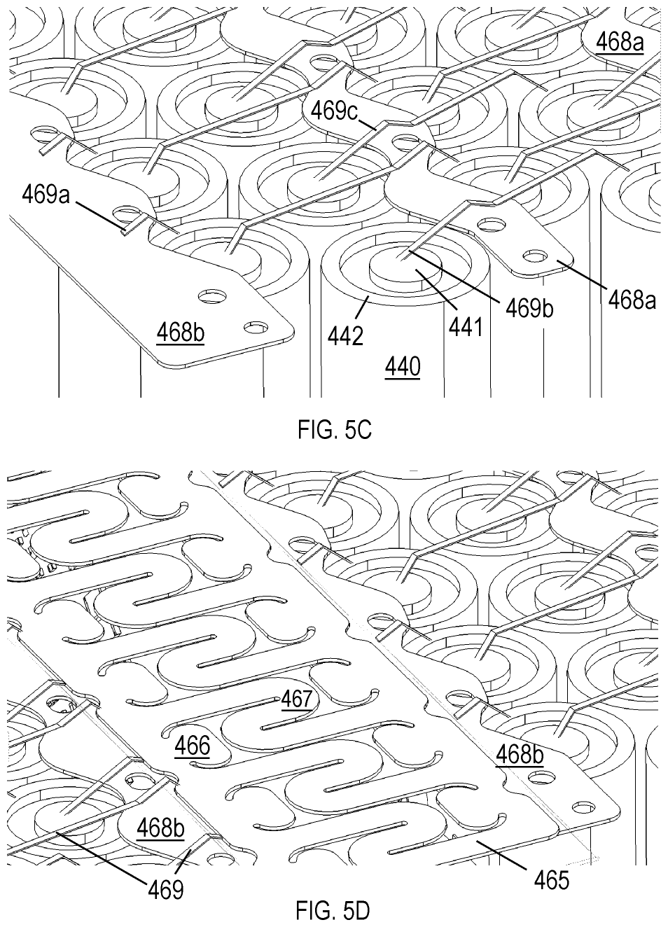

The battery module 430 and its components are illustrated in FIGS. 4-5D. Referring to FIG. 4, at the bottom is a base plate 431 which may serve as the main heat conduit for the secondary cells 440. The cells 440 may be arranged in a bottom cell carrier 432 comprised of insulating material which aligns the cells 440 in a hexagonal close-packed arrangement, which in turn provides the densest possible array while maintaining electrical isolation (i.e., a gap) between the cells 440. Module sidewalls 433 define the outer extent of the module 430 and serve to contain the potting (not shown) between the cells of the array 440. The module sidewalls 433 comprise datums for positioning the cell carrier 432 within the sidewalls 433. The potting material is an electrically insulating, thermally conductive adhesive, which bonds the cells to the base plate 431, the cell carrier 432 and each other. A top cell carrier 434 comprised of insulating material may be placed atop the cell array 440 and may serve to isolate the cell terminals from each other. An intercell busbar array 468 may be placed over one or more rows of cells and may connect the positive terminals of one set of cells to the negative terminals of another set. First and last sets of cells may be provided end-of-module busbars configured to be joined to an intra-row 465, inter-row 464, or end-of-row 463 busbar. Intercell busbars 468 comprise low-profile, stamped sheet metal and may be welded to the cell terminals without ribbon bonds. The busbars 468 may be made from any suitable metal, such as aluminum or copper, with aluminum preferred for weight savings. Alternatively, an array of ribbon bonds may be used to connect individual cell terminals to the busbars 468 and an adjacent row of cells 440. The cell-to-cell interconnects 468 may be configured to connect rows in parallel and columns in series, although other configurations are possible. In this embodiment, two rows of 13 cells may be connected in parallel for a total of 26 cells in parallel. Pairs of rows may be connected in series into a column 16 cells in length. The number of cells in a row and rows in a column may vary according to the current and voltage requirements of the application.

FIG. 5A shows a detail view of the cell array 440, intercell busbars 468, top cell carrier 434, and interconnect arrangement. In a first connection, a first busbar 464a may be connected to the positive terminals 441 of the cells in the first two rows, as shown. Note that the intercell busbars 468 may be physically isolated from the cells 440 by the top cell carrier 434, and may be electrically coupled to the cells only through negative 461 and positive 462 electrode welded tabs 466a and 466b, respectively. In a second connection, an intercell busbar 468 may be connected to the negative terminals 442 of the cells in the first two rows via negative electrode 461 welding tabs 466a. In a third connection, the same intercell busbar 468 may be connected to the positive terminals 441 of the cells in the next two rows via positive electrode 462 welded tabs 466b. In a fourth connection, the second pair of rows may be connected to a second intermediate busbar 468, and so forth. In this way, all the rows may be paired and connected in parallel, with the aggregated rows connected in series to form a column. Referring to FIG. 5B, the final pair of rows may be connected to an intra-row busbar 465 in a similar manner as other connections herein, or any other method known to one skilled in the art (not shown). The intra-row busbar 465 may be used to couple the last intercell busbar 468a of one module and the first intercell busbar 466b of another module in the same row. The intra-row busbar 465 may comprise a conductive metal sheet 465a, such as aluminum, and may be covered by an insulator 465b in the space between the modules.

FIG. 5C shows a detail view of the cell array 440, with alternative interconnect arrangement including intercell busbars 468a and ribbon bonds 469a-469c, wherein the top cell carrier 434 has been omitted for clarity. In a first connection, an end-of-module busbar 468b may be connected to the negative terminals 442 of the cells in the first two rows via ribbon bonds 469a. Note that the first busbar 466b may be physically isolated from the cells 440 by the top cell carrier 434 (not shown) and may be electrically coupled to the cells only through the ribbon bonds 469a-469c. In a second connection, an intercell busbar 468a may be connected to the positive terminals 441 of the cells in the first two rows via ribbon bonds 469b and 469c. In a third connection, the same intercell busbar 468a may be connected to the negative terminals 442 of the cells in the next two rows via ribbon bonds. In a fourth connection, the second pair of rows may be connected to a second intercell busbar 468a, and so forth. In this way, all the rows may be paired and connected in parallel, with the aggregated rows connected in series to form a column. The final pair of rows may be connected to the last busbar 468b by ribbon bonds 469 as shown in FIG. 5D. Also shown in FIG. 5D, an intra-row busbar 465 may be used to couple the last busbar 468b of one module and the first busbar 466b of another module in the same row. The intra-row busbar 465 may comprise strain relief features, such as welding tabs 466 and S-bend traces 467. These features may absorb stress between modules by deformation strain, thereby protecting the busbar welds.

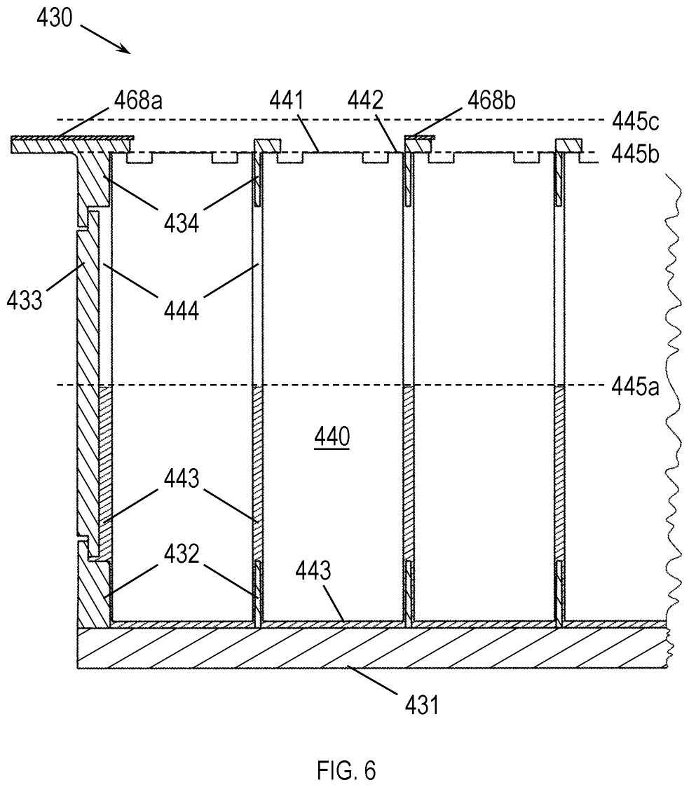

FIG. 6 gives a section view of the secondary cells housed within a module 430 wherein the details of the short thermal path can be more clearly seen. The cells 440, which in operation generate most of their heat at the cell bottom away from the topside terminals 441, 442, may be mechanically and thermally coupled to the module base plate 431 through holes in the module cell carrier bottom 432 via a thermally conductive potting material 443. The potting material 443 may fill the spaces between the base plate 431, the cell carrier bottom 432, the module sidewalls 433 and the cylindrical cells 440 to a first level 445a part way up the sides of the cells 440. In this way, the shortest thermal path between the cells 440 and the first level heat sink (the base plate 431) may be realized. Cell-to-cell separation may be maintained at the tops of the cells 440 by the cell carrier top 434. The tops of the cells 440 are coplanar which facilitates ribbon bonding (not shown) to the intercell interconnects 468a—b, which rest upon the cell carrier top 434. The space above the thermally conductive potting material 443, including the remaining spaces between the cylindrical cells 440, the module sidewalls 433, the cell carrier top 434, the inter-cell interconnects 468 and the ribbon bonds (not shown), may be filled with a thermally insulating and flame-retardant foam 444 up to a second level 445b at the tops of the cells 440. Also, the thermally insulating foam 444 may provide passive propagation resistance (PPR) between cells 440 in the event of a thermal runaway event. In general, the interstitial cell material and/or module potting material may be selected from a group including a potting/adhesive material, a thermally conductive material, an electrically insulating material, and a thermally insulating material. Any selected material may comprise a non-mutually exclusive plurality of these properties. Furthermore, the one or more interstitial cell and/or module potting materials may fill to a level part way up the cells 445a, to the top of the cells 445b or to a level above the cells 445c.

Referring again to FIG. 4, a module monitoring system 450 may be used to assess the health and performance of the battery module 430. The system 450 comprises a module monitoring board 451, voltage and temperature sensors (not shown), and a wiring harness 454. The wiring harness 454 connects the busbars 468 to the module monitoring board 451 for voltage sensing and leveling. Alternatively, interconnects may be provided by a flex or stiff printed circuit board (PCB). The module sidewalls 433 can further include features for ultrasonically or heat-staked wires or a PCB and access ports for integrated thermal sensing 452. In one embodiment as shown in FIG. 4, the one or more integrated thermal sensors 452 are illustrated as a bundle of two or more wires and/or other components, exploded, i.e., offset from the module sidewall 433 for illustrative purposes.

It may be appreciated that the dimensions of the battery pack can vary based on the number of modules 430 it incorporates and the number and arrangement of cells 440 in each module 430. Additionally, the battery pack can further correspond to custom shapes and configurations that may be tailored to a specific vehicle or for a specific purpose, such as a specific vehicle range.

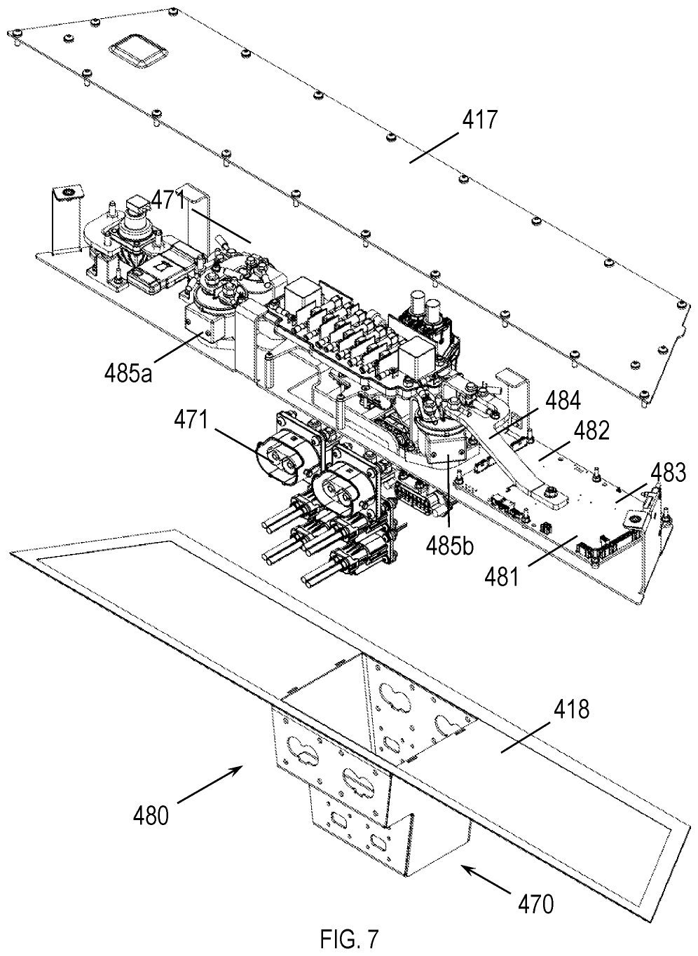

Referring again to FIG. 1B, the battery frame 410 may comprise a battery management system (BMS) 480 compartment 416 separated from the sealed section 415 housing the battery modules 430. The frame 415 may be secured to one or more other components of the vehicle via frame mounting bracket 413. The BMS compartment 416 may further comprise bottom 417 and top 418 plates enclosing the control device section formed in the structural frame. Various components of the BMS 480 are displayed in FIG. 7, which is shown in an inverted orientation for better component visibility. Components housed in the enclosure 417 and 418 may include the BMS control board 481, fast-charging circuitry 482 and solar charging circuitry 483 structurally joined to a bracket 484. In operation, the BMS control board 481 monitors the pack 400 temperature and voltage levels as well as its charge level. The BMS 480 may further configure the battery pack 400 and electrical system 500 into various modes by monitoring and conditioning the voltage and current levels of the modules 430 and the pack 400. The various modes may be configured by opening and closing contactors 485a and 485b between the various power sources and sinks in the vehicle. For example, when making a connection, the BMS 480 may monitor the voltage on either side of an open contact and adjust the voltages to within a predefined range before closing the contactor. Likewise, the BMS 480 may monitor the current through closed contacts and make sure it is at or below a prescribed level before opening the contactor.

During a grid charging event, the BMS 480 may monitor pack temperature and may condition the pack for charging, if necessary. The fast-charging circuitry 482 may then monitor and control the charging operation to avoid overheating and/or overcharging, which could cause battery damage. Similarly, the solar charging circuitry 483 may monitor the voltage state of the battery and current through the solar cells and sense when solar power is available for charging the battery. If solar power is available, the board 483 may then place the battery/electrical system into the solar charging mode, in which the battery 400 is connected to the solar panel inverter. When the car is in the off state, the BMS 480 may disconnect the battery 400 from the auxiliary systems, such as the air conditioner and CPU, which may draw a small amount of power in their standby state, to prevent loss of energy. In this way energy leakage from the battery may be minimized.

A power distribution unit (PDU) 470 may be disposed on the top of the BMS compartment lid 418. The PDU 470 may connect the battery to various power cable connectors 471 on the outside of the PDU 470. Power distribution cables may be plugged into the connectors and feed the various electrical systems of the vehicle, such as the powertrain, HVAC system, and electrical system, including lights, instrumentation and infotainment systems.

Referring again to FIG. 6, consideration may be given to the safety of the battery pack 400. Cell 440 failure may be addressed by various structures and methods. The cells may be passively thermally isolated by interstitial potting material 443, passively fire suppressed by foam material 444, and isolated from the frame 410 by a sheet of flame-retardant material above cell array. Referring again to FIGS. 1A and 1B, the battery pack 400 may be vented toward the rear of the vehicle to prevent hot gas leaks from entering the cabin. Also, the battery pack 400 may be enclosed in the body of the vehicle to prevent exposure to the environment (e.g., flood waters). Impact resistance may be built up through a combination of aluminum extruded members 411, ribs 412 and other structures welded into a frame structure with multiple compartments 415, 416, cover plate 414, base plates 431, cooling plate 420, welded connectors 460, and brazed connections 421, 422. Impact resistance and mechanical durability depends on properly formed construction and electrical connections 460.

Therefore, these improvements to the battery pack 400 provide a high energy density storage system having advantages of small volume, reduced weight, and improved costs of manufacture resulting in improved yield and reduced cost. The battery pack has further advantages of reduced dimensions and an improved thermal control system that does not require exposure of the battery pack to airflow for proper thermal control. Moreover, the battery pack may be housed completely within an aerodynamic enclosure avoiding drag-inducing openings in the panels of the vehicle rendering it suitable for aircraft, spacecraft and ultra-efficient vehicles.

While certain configurations of structures have been illustrated for the purposes of presenting the basic structures of the present invention, one of ordinary skill in the art will appreciate that other variations are possible which would still fall within the scope of the appended claims. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A battery pack for a solar-electric vehicle, the battery pack comprising:
a frame forming one or more compartments;
a cooling plate disposed in thermal communication with a bottom surface of the frame, the cooling plate including an inlet, an outlet, and one or more fluid channels;
one or more battery modules, each battery module being configured to be received within a compartment of the frame, each battery module including:
a module conductor in thermal communication with the bottom surface of the frame;
a first cell carrier configured to be disposed on the module conductor;
a plurality of secondary cells having a ground end and an electrode end, the ground end being oriented proximate the first cell carrier and being in thermal communication with the module conductor;
a second cell carrier configured to be disposed proximate the electrode ends of the plurality of secondary cells;
one or more interconnects connecting in parallel and in series the plurality of secondary cells;
a first potting material interstitially disposed between the plurality of secondary cells and filling at least a portion of the space extending from the ground ends to the electrode ends of the plurality of secondary cells;
a second potting material extending from proximate the first potting material to the electrode ends and/or beyond the electrode ends of the one or more secondary cells;
an insulating layer disposed on a potting material disposed to a level above the one or more secondary cells;
a cover disposed proximate the insulating layer configured to encapsulate the module and thereby thermally contain the one or more secondary cells;
a module management system configured to control each battery module, the module management system comprising:
a motherboard;
one or more temperature sensors configured to sense and control temperature within the battery module, the one or more temperature sensors disposed proximate the one or more secondary cells and/or the module management system; and
one or more voltage sensors in electric communication with one or more voltage levelers and the module management system,
wherein the module management system is configured to sense temperature of the module and sense and control a voltage of the one or more voltage levelers;
one or more intra-row busbars and one or more inter-row busbars, wherein the one or more battery modules are electrically connected by the one or more intra-row busbars and/or the one or more inter-row busbars;
a lid configured to encapsulate and thermally isolate the battery pack and the one or more secondary cells therein;
a power distribution unit comprising connectorized power ports corresponding to each type of load of the solar-electric vehicle; and
a battery management system configured to control the battery pack, wherein the battery pack is adapted to:
sense when solar power is available and initiate the charging of the battery pack when power demand from one or more of the vehicle systems is not present,
sense when solar power is available and initiate the charging of the battery pack when power demand from one or more of the vehicle systems is present, and
sense when the vehicle is OFF, and initiate an auxiliary disconnect to prohibit power draw from the battery to any of the vehicle systems.

2. The battery pack of claim 1, wherein said one or more interconnects are selected from the group consisting of: stamped voltage levelers including ribbon bonds, and stamped voltage levelers including welded tabs.

3. The battery pack of claim 1, wherein said cooling plate further comprises cooling plate portions, adapted to induce turbulent flow within the one or more fluid channels.

4. The battery pack of claim 1 wherein the first potting material comprises thermally conductive properties.

5. The battery pack of claim 1 wherein the second potting material comprises fire retardant and/or suppression properties.

6. The battery pack of claim 1 wherein the insulating layer comprises fire retardant and/or suppression properties.

7. The battery pack of claim 1 wherein the one or more intra-row busbars and the one or more inter-row busbars are selected from the group consisting of: stamped metal sheets, and stamped metal sheets with stress relief features.

8. The battery pack of claim 1, wherein the intra-row busbars comprise strain relief portions including welding tabs and/or S-bend traces, configured to absorb stress between the one or more battery modules.

9. The battery pack of claim 1, wherein the one or more intra-row busbars are made of copper and each intra-row busbar comprises a cross-sectional dimension having a maximum height of about 1 mm and a width of about 75 mm.

10. The battery pack of claim 9, wherein the one or more intra-row busbars further comprise a surrounding layer of insulation of about 1 mm thickness.

11. The battery pack of claim 1 further comprising module-level interconnect terminals, wherein the distances between the battery management and the module-level interconnect terminals are minimized, and the overall weight of the battery pack is minimized.

12. A battery pack for a solar-electric vehicle, the battery pack comprising:
a frame forming one or more compartments;
a cooling plate disposed in thermal communication with a bottom surface of the frame, the cooling plate including an inlet, an outlet, and one or more fluid channels;
one or more battery modules, each battery module being configured to be received within a compartment of the frame, each battery module including:
a module conductor in thermal communication with the bottom surface of the frame;
a first cell carrier configured to be disposed on the module conductor;
a plurality of secondary cells having a ground end and an electrode end, the ground end being oriented proximate the first cell carrier and being in thermal communication with the module conductor;
a second cell carrier configured to be disposed proximate the electrode ends of the plurality of secondary cells;
one or more interconnects connecting in parallel and in series the plurality of secondary cells;
a first potting material interstitially disposed between the plurality of secondary cells and filling at least a portion of the space extending from the ground ends to the electrode ends of the plurality of secondary cells;
a second potting material extending from proximate the first potting material to the electrode ends and/or beyond the electrode ends of the one or more secondary cells;
an insulating layer disposed on a potting material disposed to a level above the one or more secondary cells;
a cover disposed proximate the insulating layer configured to encapsulate the module and thereby thermally contain the one or more secondary cells;
a module management system configured to control each battery module, the module management system comprising:
a motherboard;
one or more temperature sensors configured to sense and control temperature within the battery module, the one or more temperature sensors disposed proximate the one or more secondary cells and/or the module management system; and
one or more voltage sensors in electric communication with one or more voltage levelers and the module management system,
wherein the module management system is configured to sense temperature of the module and sense and control a voltage of the one or more voltage levelers;
one or more intra-row busbars and one or more inter-row busbars, wherein the one or more battery modules are electrically connected by the one or more intra-row busbars and/or the one or more inter-row busbars;
a lid configured to encapsulate and thermally isolate the battery pack and the one or more secondary cells therein;
a power distribution unit comprising connectorized power ports corresponding to each type of load of the solar-electric vehicle; and
a battery management system configured to control the battery pack, wherein the battery pack is adapted to:
sense when solar power is available and initiate the charging of the battery pack when power demand from one or more of the vehicle systems is not present,
sense when solar power is available and initiate the charging of the battery pack when power demand from one or more of the vehicle systems is present, and
sense when the vehicle is OFF, and initiate an auxiliary disconnect to prohibit power draw from the battery to any of the vehicle systems.

13. The battery pack of claim 12, wherein said one or more interconnects are selected from the group consisting of: stamped voltage levelers including ribbon bonds, and stamped voltage levelers including welded tabs.

14. The battery pack of claim 13, wherein said cooling plate further comprises cooling plate portions, adapted to induce turbulent flow within the one or more fluid channels.

15. The battery pack of claim 14, wherein the first potting material comprises thermally conductive properties.

16. The battery pack of claim 15, wherein the one or more intra-row busbars and the one or more inter-row busbars are selected from the group consisting of: stamped metal sheets, and stamped metal sheets with stress relief features.

17. The battery pack of claim 16, wherein the intra-row busbars comprise strain relief portions including welding tabs and/or S-bend traces, configured to absorb stress between the one or more battery modules.

18. The battery pack of claim 17, wherein the one or more intra-row busbars are made of copper and each intra-row busbar comprises a cross-sectional dimension having a maximum height of about 1 mm and a width of about 75 mm.

19. The battery pack of claim 18, wherein the one or more intra-row busbars further comprise a surrounding layer of insulation of about 1 mm thickness.

20. The battery pack of claim 19 further comprising module-level interconnect terminals, wherein the distances between the battery management and the module-level interconnect terminals are minimized, and the overall weight of the battery pack is minimized.
